(19) United States
(12) Patent Application Publication
(10) Pub. No.: US 2022/0120067 A1
(43) Pub. Date: Apr. 21, 2022

(54) MAGNETIC SHOWER DEVICE

(71) Applicant: Purity (Xiamen) Sanitary Ware Co., Ltd., Xiamen City (CN)

(72) Inventors: JAMES WU, Taichung City (TW); ALEX WU, Taichung City (TW); CE-WEN YANG, Xiamen City (CN); CHING-YIN WU, Taichung City (TW)

(73) Assignee: Purity (Xiamen) Sanitary Ware Co., Ltd., Xiamen City (CN)

(21) Appl. No.: 17/073,938

(22) Filed: Oct. 19, 2020

(51) Int. Cl. E03C 1/06

(52) U.S. Cl. CPC E03C 1/06

(57) ABSTRACT

A magnetic shower device includes a showerhead, a shower bracket, a first positioning member, and a second positioning member. The showerhead has a head body and a handle, in which the head body has a front portion and a rear portion positioned back to back. An attaching face is disposed at the rear portion. The shower bracket includes a bracket body and a holder, in which the bracket body is for connecting an inlet tube. The holder connected to the bracket body has a left fin, a right fin, and an attached face which is between the left fin and the right fin and corresponds to the attaching face. The first positioning member is disposed at the rear portion of the showerhead. The second positioning member is disposed at the holder of the shower bracket. When the attaching face of the showerhead is attached to the attached face of the shower bracket, the first positioning member and the second positioning member are attracted to each other by a magnetic force, such that the attaching face of the rear portion of the showerhead is attracted to the attached face of the shower bracket and the head body is supported by the left fin and the right fin.

### BACKGROUND OF THE INVENTION

### Technical Field

The present invention relates to a shower device, and more particularly to a magnetic shower device.

### Description of Related Art

Nowadays, a common shower device includes a showerhead and a shower bracket having a C-shaped groove for placing a handle of the showerhead. When in use, a user needs to move the handle of the showerhead to an upper opening of the C-shaped groove accurately and put the handle into there, so the showerhead can be engaged stably in the shower bracket. However, the ways of taking out and putting back the showerhead are not intuitive and inconvenient for the user. Hence, it is still a need to provide an improvement in the design of the known shower device so as to overcome the aforementioned drawbacks.

### BRIEF SUMMARY OF THE INVENTION

In view of the above, the primary objective of the present invention is to provide a magnetic shower device, a showerhead, and a shower bracket of which can be rapidly positioned and engaged with each other in a magnetic-attraction manner.

The present invention provides a magnetic shower device for connecting an inlet tube. The magnetic shower device includes a showerhead, a shower bracket, a first positioning member, and a second positioning member. The showerhead has a head body and a handle, in which the head body has a front portion and a rear portion positioned back to back. The showerhead includes a spray face disposed at the front portion, and the rear portion has an attaching face. The shower bracket includes a bracket body and a holder, in which the bracket body is for connecting the inlet tube. The holder connected to the bracket body has a left fin, a right fin, and an attached face which is between the left fin and the right fin and corresponds to the attaching face. The first positioning member is disposed at the rear portion of the showerhead. The second positioning member is disposed at the holder of the shower bracket and is for attracting to each other with the first positioning member by a magnetic force. When the attaching face of the showerhead is attached to the attached face of the shower bracket, the first positioning member and the second positioning member are attracted to each other by the magnetic force, such that the attaching face of the rear portion of the showerhead is attracted to the attached face of the shower bracket and the head body is supported by the left fin and the right fin.

The advantage of the present invention is that when a user is to put the showerhead back at the shower bracket, the rear portion of the showerhead can be moved to a position close to the holder. The attaching face of the showerhead can be attracted to the attached face of the holder through the magnetic force between the first positioning member and the second positioning member, so as to achieve the effect of rapid positioning between the showerhead and the shower bracket. In addition, since the head body is supported by the left fin and the right fin of the holder, the holder provides a support force to the head body to prevent the showerhead from being subject to a downward force and detached from the holder.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a magnetic shower device of a first preferred embodiment of the present invention;

FIG. 2 is a partial exploded schematic view of the magnetic shower device of the first preferred embodiment;

FIG. 3 is a partial exploded schematic view of the magnetic shower device of the first preferred embodiment;

FIG. 4 is a partial enlarged schematic view of the magnetic shower device of the first preferred embodiment;

FIG. 5 is a cross-sectional schematic view of FIG. 4 along lines A-A;

FIG. 6 is a partial enlarged schematic view of the magnetic shower device of the first preferred embodiment;

FIG. 7 is a partial enlarged schematic view of the magnetic shower device of the first preferred embodiment;

FIG. 8 is a cross-sectional schematic view of FIG. 4 along a first horizontal reference plane;

FIG. 9 is a cross-sectional schematic view of FIG. 4 along a second horizontal reference plane;

FIG. 10 is a schematic view of an operating state of the magnetic shower device of the first preferred embodiment;

FIG. 11 is a cross-sectional schematic view of the magnetic shower device of a second preferred embodiment;

FIG. 12 is a cross-sectional schematic view of the magnetic shower device of a third preferred embodiment;

FIG. 13 is a cross-sectional schematic view of the magnetic shower device of a fourth preferred embodiment;

FIG. 14 is a cross-sectional schematic view of a fifth embodiment along a second horizontal reference plane;

FIG. 15 is a cross-sectional schematic view of a sixth embodiment along a second horizontal reference plane.

### DETAILED DESCRIPTION OF THE INVENTION

The following illustrative embodiments and drawings are provided to illustrate the disclosure of the present invention, these and other advantages and effects can be clearly understood by persons skilled in the art after reading the disclosure of this specification.

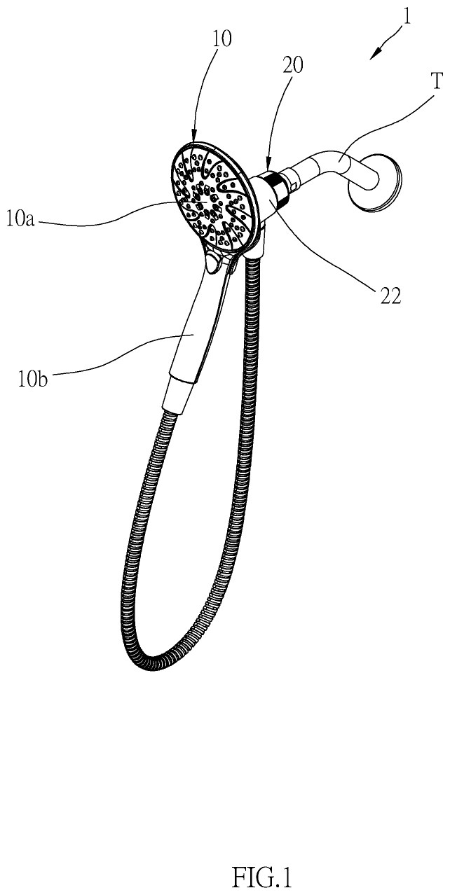

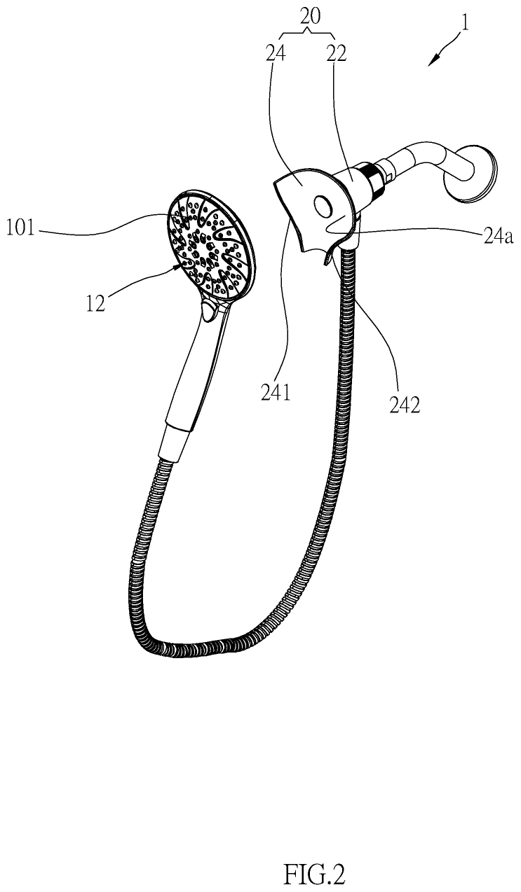

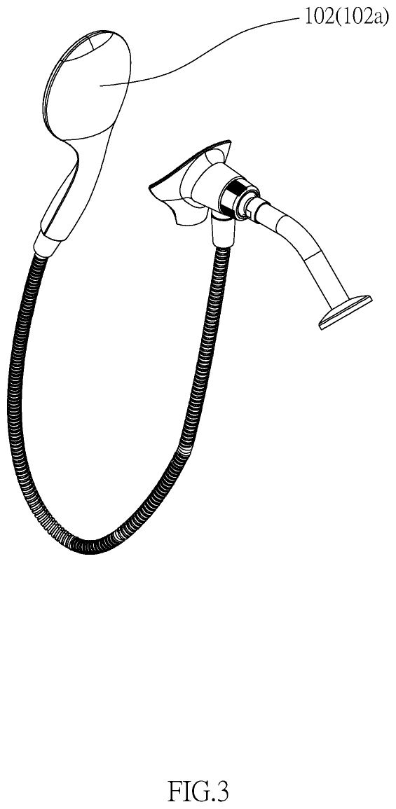

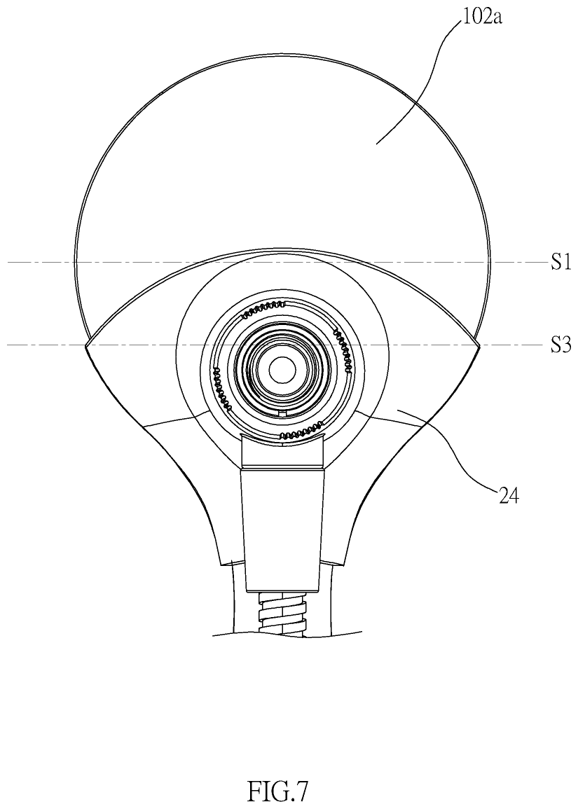

As shown in FIG. 1 to FIG. 11, a magnetic shower device 1 according to a first preferred embodiment of the present invention is for connecting an inlet tube T and includes a showerhead 10, a shower bracket 20, a first positioning member 30, and a second positioning member 40.

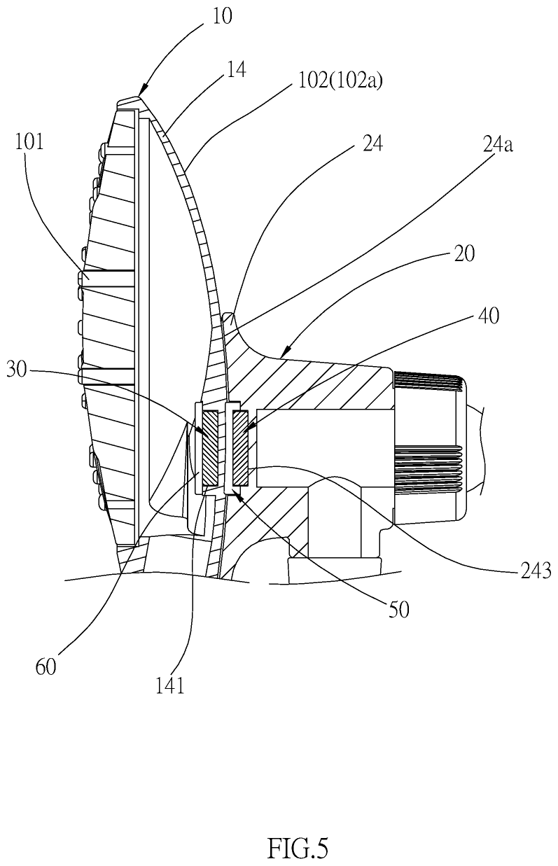

As shown in FIG. 1 to FIG. 4, the showerhead 10 has a head body 10a and a handle 10b, in which the head body 10a has a front portion 101 and a rear portion 102 positioned back to back. The showerhead 10 includes a spray face 12 disposed at the front portion 101, and the rear portion 102 has an attaching face 102a. The handle 10b is for a user to hold. The shower bracket 20 includes a bracket body 22 and a holder 24, in which the bracket body 22 connects to the inlet tube T and the holder 24 connected to the bracket body 22 has a left fin 241, a right fin 242, and an attached face 24a which is between the left fin 241 and the right fin 242 and corresponds to the attaching face 102a of the showerhead 10. As shown in FIG. 5, the first positioning member 30 is disposed at the rear portion 102 of the showerhead 10, and the second positioning member 40 is disposed at the holder 24 of the shower bracket 20. The first positioning member 30 and the second positioning member 40 can be attracted to each other through a magnetic force.

When the attaching face 102a is attached to the attached face 24a of the shower bracket 20, the first positioning member 30 and the second positioning member 40 are attracted to each other through the magnetic force, such that the attaching face 102a of the rear portion 102 of the showerhead 10 is attracted to the attached face 24a of the holder 24. The attaching face 102a contacts the attached face 24a, and the head body 10a is supported by the left fin 24a and the right fin 242. When the user is to put the showerhead 10 at the shower bracket 20, the rear portion 102 of the showerhead 10 can be moved to a position close to the holder 24. The attaching face 102a of the showerhead 10 can be attracted to the attached face 24a of the holder 24 through the magnetic force between the first positioning member 30 and the second positioning member 40, so as to achieve the effect of rapid positioning between the showerhead 10 and the shower bracket 20.

In the current embodiment, the first positioning member 30 and the second positioning member 40 are exemplified by magnets. In an alternative embodiment, one of the first positioning member 30 and the second positioning member 40 can be a magnet while the other one can be a magnetic substance, such as iron, nickel, or cobalt.

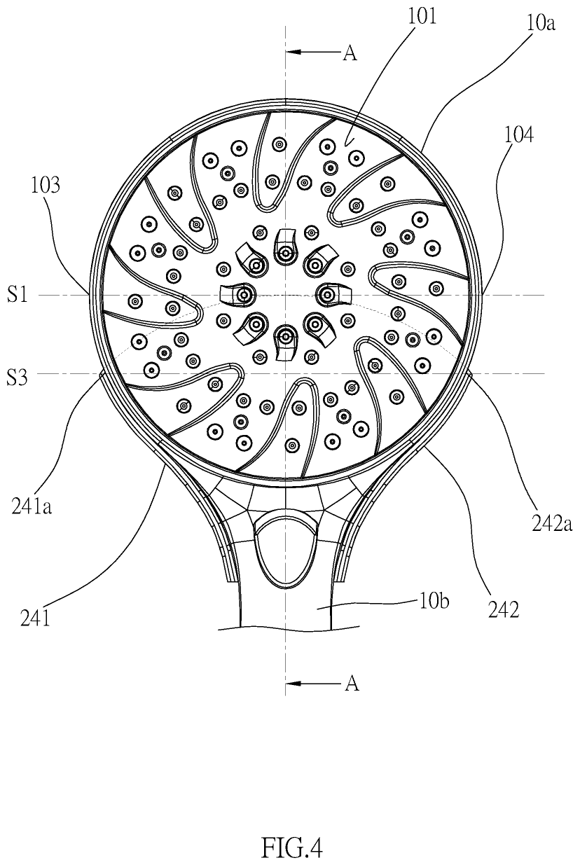

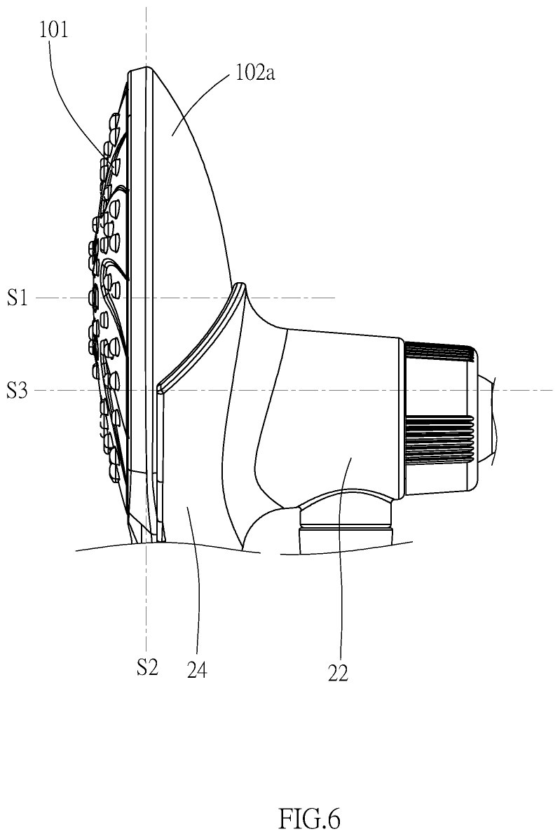

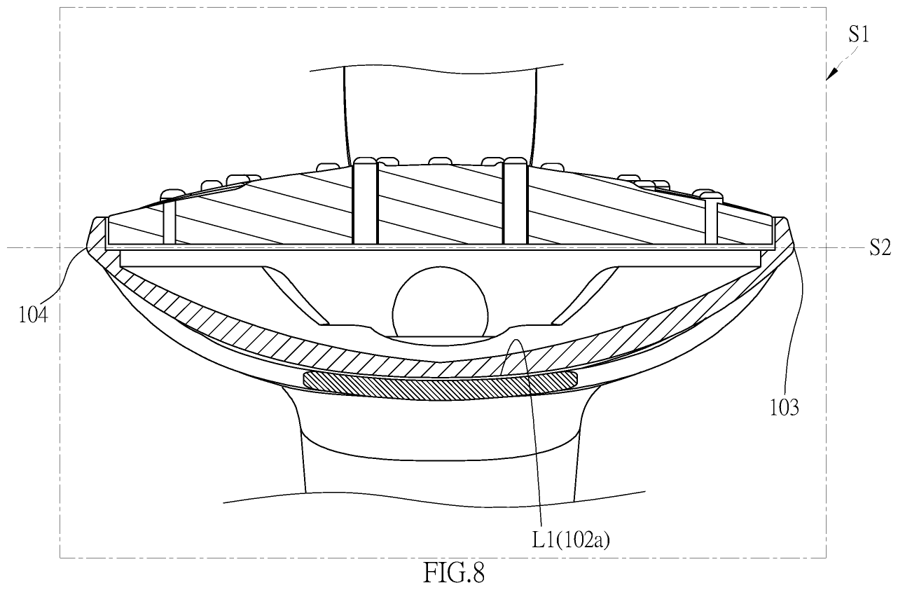

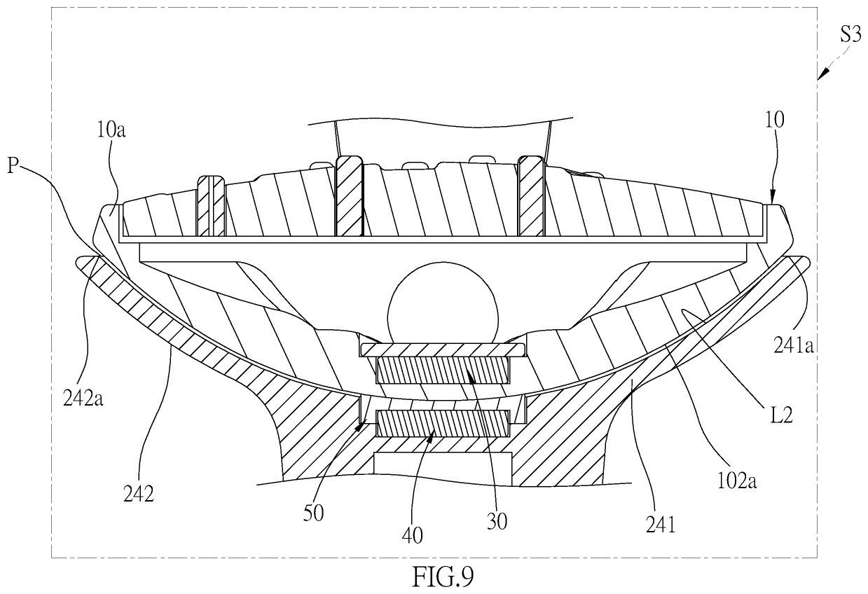

As shown in FIG. 4 to FIG. 9, the head body 10a of the showerhead 10 has a left endpoint 103 and a right endpoint 104, and a distance between the left endpoint 103 and the right endpoint 104 is the greatest distance of the head body 10a of the showerhead 10. An open side P is between the left fin 241 and the right fin 242. An inner edge of the open side P has a left end 241a and a right end 242a, and between the left end 241a and the right end 242a is the widest part of the inner edge of the open side P. The greatest distance of the head body 10a of the showerhead 10 is greater than a minimum distance between the left end 241a and the right end 242a of the open side P. A first horizontal reference plane S1 (shown in FIG. 4), a vertical reference plane S2 (shown in FIG. 6) perpendicular to the first horizontal reference plane S1, and a second horizontal reference plane S3 (shown in FIG. 4) are defined herein. Both the first horizontal reference plane S1 and the vertical reference place S2 pass through the left endpoint 103 and the right endpoint 104 of head body 10a of the showerhead 10. As shown in FIG. 8, the attaching face 102a and the first horizontal reference plane S2 intersect at a first line L1 which is at the same side of the vertical reference plane S2 as the open side P. The second horizontal reference plane S3 is parallel to the first horizontal reference plane S1 and passes through the left end 241a and the right end 242a of the open side P. As shown in FIG. 9, the attached face 24a and the second horizontal reference plane S3 intersect at a second line L2, and a minimum distance between two ends of the second line L2 is less than or equal to twice a radius of curvature thereof.

In the current embodiment, the open side P illustrates a width of which decreases gradually from top to bottom, but is not limited thereto. In practice, the width of the open side P can also be set in other ways, such as a consistent width without gradual change. In the current embodiment, the attaching face 102a of the showerhead 10 and the attached face 24a of the holder 24 are illustrated as arc surfaces while the first line L1 and the second line L2 are illustrated as arc lines. In an alternative embodiment, the attaching face 102a of the showerhead 10 and the attached face 24a of the holder 24 can be flat surfaces, concave surfaces, convex surfaces, or a combination of at least two of a flat surface, a concave surface, and a convex surface. The first line L1 and the second line L2 can also be straight lines, arc lines, or a combined line segment including a straight line and an arc line.

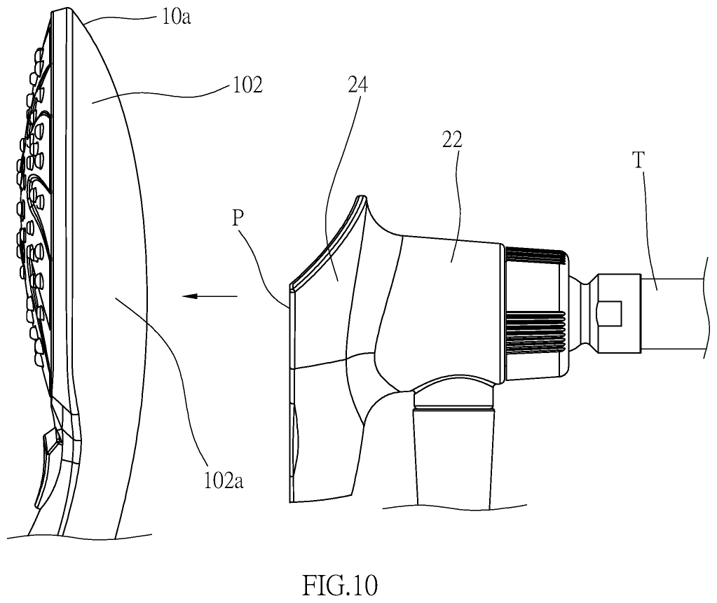

With the aforementioned design, as shown in FIG. 10, the showerhead 10 can be pulled by an external force to move the head body 10a of the showerhead 10 away from the bracket body 22 and can be separated directly from the shower bracket 20 via the open side P of the holder 24, which improves the usage of known showerheads which must be drawn upward relative to the shower bracket before being taken out. Not only that, the head body 10a of the showerhead 10 can be moved closer to the bracket body 22 and enter an accommodating space between the left fin 24a and the right fin 242 through the open side P of the holder 24. The head body 10a is then positioned on the attached face 24a of the holder 24 through the magnetic force between the first positioning member 30 and the second positioning member 40. The head body 10a of the showerhead 10 is thus supported by the holder 24 and is fixed at the shower bracket 20, achieving the effect of rapid positioning between the showerhead 10 and the shower bracket 20. Since both sides of the lower half of the head body 10a are supported by the left fin 24a and the right fin 242 of the holder 24, the holder 24 provides a support force to the head body 10a to prevent the showerhead 10 from being subject to a downward force and detached from the holder 24. It is noted that the holder 24 can share the force of fixing the showerhead 10, the first positioning member 30 or the second positioning member 40 can use only one magnet respectively or magnets with lower magnetic attraction, so as to reduce the magnet cost of the first positioning member 30 and the second positioning member 40.

As shown in FIG. 5, the magnetic shower device 1 includes a buffer pad 50. The showerhead 10 includes a casing 14 having the rear portion 102. The attaching face 102a is located at one side of the casing 14 while a first recess 141 is concavely formed from a surface of the casing 14 and located at the other side of the casing 14. A second recess 243 is concavely formed from the attached face 24a. The first positioning member 30 is disposed in the first recess 141 while the second positioning member 40 is disposed in the second recess 243. The first recess 141 has an opening which can be fixedly closed via a closure member 60 by welding or other fixing ways, such that the first positioning member 30 can be stably disposed in the first recess 141 and be prevented from rusting. The buffer pad is disposed on the attached face 24a and closes an opening of the second recess 243. In the current embodiment, the second positioning member 40 is disposed in the second recess 243 concavely formed from the attached face 24a. In practice, the second positioning member 40 can be disposed in a recess at the other side of the holder 24 relative to the attached face 24a. In an alternative embodiment, the closure member 60 can be fixed to the opening of the first recess 141 by other means, such as gluing or screwing.

When the attaching face 102a of the showerhead 10 is attached to the attached face 24a of the holder 24 by the magnetic force between the first positioning member 30 and the second positioning member 40, the buffer pad 50 is to prevent scratches and noise when the showerhead 10 and the shower bracket contact each other and to increase the friction between the attaching face 102a and the attached face 24a. The buffer pad 50 can be made of materials such as rubber, silicone rubber, and the like. It is noted that, in the current embodiment, the buffer pad 50 is disposed at the attached face 24a. In an alternative embodiment, the buffer pad 50 can be disposed at the attaching face 102, or two buffer pads are respectively disposed on the attached face 24 and the attaching face 102, which can also achieve the effects of scratch resistance, noise reduction, and friction increase.

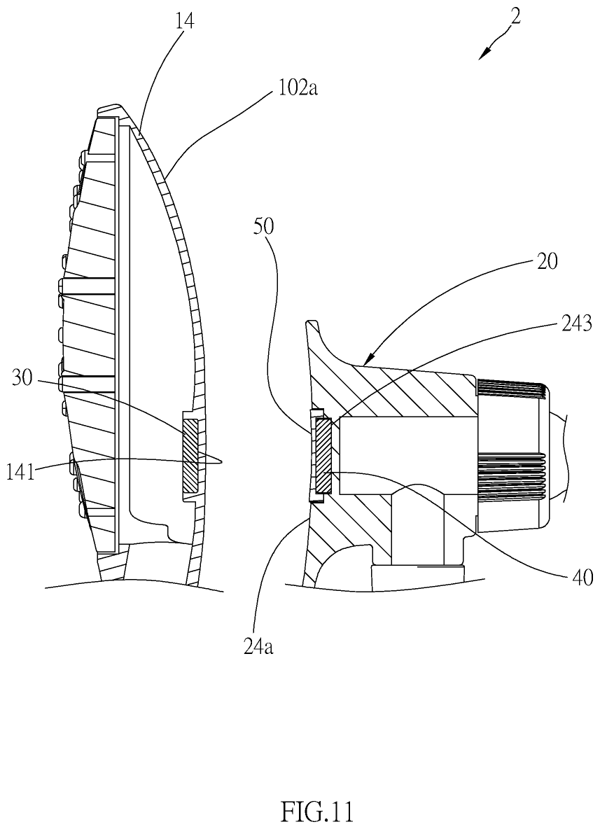

A magnetic shower device 2 of a second embodiment according to the present invention is shown in FIG. 11. The magnetic shower device 2 and the above-mentioned first embodiment differ in that a surface of the first positioning member 30 of the magnetic shower device 2 is provided with an anti-rust layer such as nickel or is coated by a layer of waterproof glue, and is directly disposed in the first recess 141, such that the first positioning member 30 is prevented from rusting. A surface of the second positioning member 40 can also be provided with an anti-rust layer or coated by waterproof glue to prevent rust.

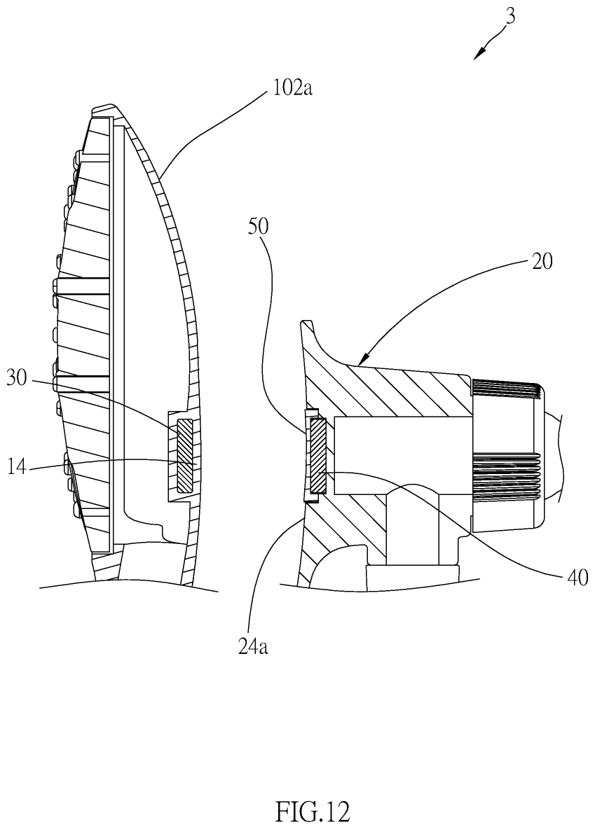

A magnetic shower device 3 of a third embodiment according to the present invention is shown in FIG. 12. The magnetic shower device 3 and the above-mentioned first embodiment differ in that a surface of the first positioning member 30 of the magnetic shower device 3 is provided with an anti-rust layer such as nickel or is coated by a layer of waterproof glue, and is embedded in the casing 14 of the showerhead 10, such that the first positioning member 30 is prevented from rusting due to long-term exposure to a humid environment. In the current embodiment, the second positioning member 40 is disposed in the second recess 243 formed concavely from the attached face 24a. In practice, a surface of the second positioning member 40 can also be provided with an anti-rust layer or coated by a layer of waterproof glue, and embedded in the holder 24 to prevent rust.

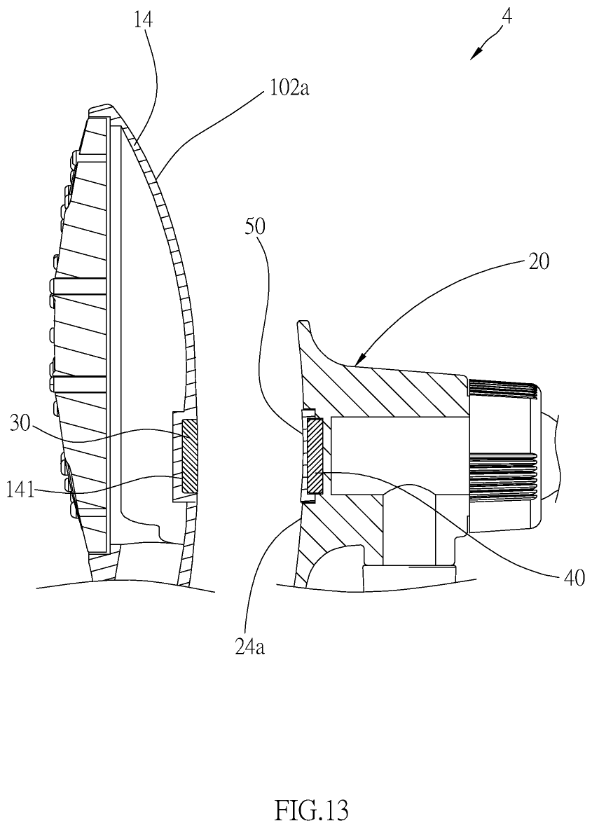

A magnetic shower device 4 of a fourth embodiment according to the present invention is shown in FIG. 13. The magnetic shower device 4 and the above-mentioned first embodiment differ in that a surface of the first positioning member 30 of the magnetic shower device 4 is provided with an anti-rust layer such as nickel or is coated by a layer of waterproof glue, and the first recess 141 is formed concavely from the attaching face 102a. In this way, not only can the first positioning member 30 be prevented from rusting due to long-term exposure to a humid environment, but the first positioning member 30 and the second positioning member 40 can be placed closer to each other to get a better effect of magnetic attraction.

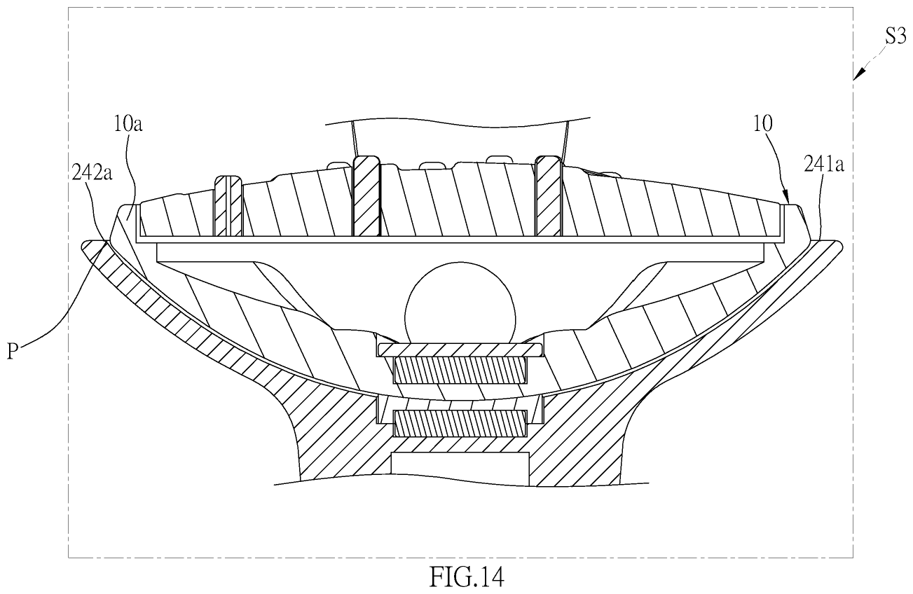

A magnetic shower device of a fifth embodiment according to the present invention is shown in FIG. 14. The magnetic shower device and the above-mentioned first embodiment differ in that, in the first embodiment, a greatest span of the head body 10a of the showerhead 10 on the second horizontal reference plane S3 is greater than a minimum distance between the left end 241a and the right end 242a of the open side P (shown in FIG. 9). However, in the fifth embodiment, a greatest span of the head body 10a of the showerhead 10 on the second horizontal reference plane S3 is less than a minimum distance between the left end 241a and the right end 242a of the open side P.

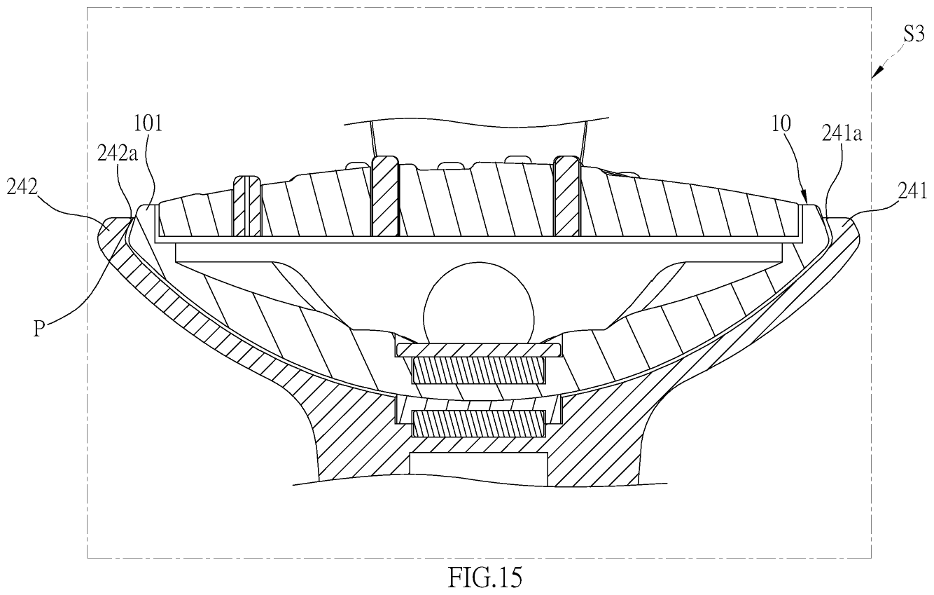

A magnetic shower device of a sixth embodiment according to the present invention is shown in FIG. 15. The magnetic shower device and the above-mentioned first embodiment differ in that a greatest span of the head body 10a of the showerhead 10 on the second horizontal reference plane S3 is greater than a minimum distance between the left end 241a and the right end 242a of the open side P, and the left fin and the right fin extend to the front portion of the showerhead and wrap the front portion.

To summary up, the advantage of the magnetic shower device of the present invention is that when the user is to put the showerhead 10 at the shower bracket 20, the rear portion 102 of the showerhead 10 can be moved to a position close to the holder 24. The attaching face 102a of the showerhead 10 can be attracted to the attached face 24a of the holder 24 through the magnetic force between the first positioning 30 and the second positioning 40, so as to achieve the effect of rapid positioning between the showerhead 10 and the shower bracket 20. When the showerhead 10 is pulled by an external force, the head body 10a of the showerhead 10 is moved away from the bracket body 22 and separated directly from the shower bracket 20 via the open side P, which improves the convenience of using showerheads and eliminates disadvantages caused by known showerheads that must be drawn upward relative to the shower bracket before being taken out.

It must be pointed out that the embodiments described above are only some embodiments of the present invention. All equivalent structures which employ the concepts disclosed in this specification and the appended claims should fall within the scope of the present invention.

1. A magnetic shower device for connecting an inlet tube, comprising:
a showerhead having a head body and a handle, in which the head body has a front portion and a rear portion positioned back to back, the showerhead includes a spray face disposed at the front portion, and the rear portion has an attaching face;
a shower bracket including a bracket body and a holder, in which the bracket body is for connecting the inlet tube, the holder connected to the bracket body has a left fin, a right fin, and an attached face which is between the left fin and the right fin and corresponds to the attaching face;
a first positioning member disposed at a rear portion of the showerhead; and
a second positioning member disposed at the holder of the shower bracket and for attracting to each other with the first positioning member by a magnetic force; wherein, when the attaching face of the showerhead is attached to the attached face of the shower bracket, the first positioning member and the second positioning member are attracted to each other by the magnetic force, such that the attaching face of the rear portion of the showerhead is attracted to the attached face of the holder, so that the head body and a connection site between the head body and the handle is supported by the left fin and the right fin;
wherein the rear portion of the head body has a first recess that is formed by recessing into either an external surface or an internal surface of the head body; the first positioning member is directly disposed in the first recess; both of the left fin and the right fin extend to an edge of the head portion.

2. The magnetic shower device of claim 1, wherein the showerhead can be pulled by an external force to move away from the bracket body and be separated from the shower bracket.

3. The magnetic shower device of claim 2, wherein an open side is formed between the left fin and the right fin, and the head body is separated from the shower bracket via the open side.

4. The magnetic shower device of claim 3, wherein a width of the open side decreases gradually from top to bottom.

5. The magnetic shower device of claim 1, comprising at least one buffer pad disposed on at least one of the attaching face and the attached face.

6. The magnetic shower device of claim 1, wherein a second recess is located at the attached face, and the second positioning member is disposed in the second recess.

7. The magnetic shower device of claim 6, wherein the first recess has an opening fixedly closed by a closure member.

8. The magnetic shower device of claim 6, wherein at least one of the first positioning member and the second positioning member is coated by a layer of waterproof glue.

9. The magnetic shower device of claim 6, wherein at least one of the first positioning member and the second positioning member is provided with an anti-rust layer.

10. (canceled)

11. A magnetic shower device for connecting an inlet tube, comprising:
a showerhead having a head body and a handle, in which the head body has a front portion and a rear portion positioned back to back, the showerhead includes a spray face disposed at the front portion, and the rear portion has an attaching face;
a shower bracket including a bracket body and a holder, in which the bracket body is for connecting the inlet tube, the holder connected to the bracket body has a left fin, a right fin, and an attached face which is between the left fin and the right fin and corresponds to the attaching face;
a first positioning member disposed at a rear portion of the showerhead; and
a second positioning member disposed at the holder of the shower bracket and for attracting to each other with the first positioning member by a magnetic force; wherein, when the attaching face of the showerhead is attached to the attached face of the shower bracket, the first positioning member and the second positioning member are attracted to each other by the magnetic force, such that the attaching face of the rear portion of the showerhead is attracted to the attached face of the holder, so that the head body and a connection site between the head body and the handle is supported by the left fin and the right fin;
wherein the first positioning member is encapsuled in the rear portion of the head portion; both of the left fin and the right fin extend to an edge of the head portion.
